(19) United States
(12) Patent Application Publication
(10) Pub. No.: US 2006/0108795 A1
(43) Pub. Date: May 25, 2006

(54) Access component for pressure retaining item (PMCap-Nozzle)

(76) Inventor: Paul Stephen Manzon, Pottstown, PA (US)

Correspondence Address: PAUL STEPHEN MANZON, 272 GRUBB RD., POTTSTOWN, PA, 19465, US

(21) Appl. No.: 10/978,251

(22) Filed: Oct. 29, 2004

(51) Int. Cl. F16L 41/00

(52) U.S. Cl. 285/197

(57) ABSTRACT

This application is for an access opening component (invention) used to provide access into a pressure retaining item. Pressure retaining item may contain degraded material at the location where the invention is to be located. What is new in the art to which my invention pertains is that installation of the access opening can be accomplished without need to cut a precise hole in the pressure retaining item or remove localized degraded material. Common access hole installation methods require cutting a precise size hole and may require removal or repair of degraded material in the pressure boundary material. The invention does not require replacement or repair of degraded pressure boundary material, and does not required cutting a precise hole size in the material as the invention can be constructed to encapsulate any area of degraded pressure boundary material or any size hole cut into the pressure boundary material.

### BACKGROUND OF THE INVENTION

This application is for a component that is attached to a pressure retaining item and provides for access into the pressure retaining item. Piping, tubing, or hose may be attached to the component through which a fluid (gas or liquid) can either enter or exit the pressure retaining item. A cover may be attached to the component which when removed provides for physical access through the component into the pressure retaining item. The component has self-structural and pressure retention integrity and maintains the structural and pressure retention integrity of the pressure retaining item to which it is attached. The component may be used in applications requiring new access openings into pressure retaining items or for replacement of access openings in pressure retaining items.

Pressure retaining items include but are not limited to items referred to as pressure vessels, tanks, towers, boilers, reactors, heat exchangers, pipe, pumps, and valves. Pressure retaining items are generally constructed of metallic material. Methods of construction of pressure retaining items include welded construction, bolted construction, riveted construction, and a completed pressure retaining item may be constructed using one or various combinations of welded, bolted, or riveted construction. Various industry Codes and Standards provide construction, operation, and inspection requirements pertaining to pressure retaining items in the United States. These include Codes and Standards published by various organizations including but not limited to the American Society of Mechanical Engineers (ASME), American National Standards Institute (ANSI), Tubular Exchanger Manufacturers Association (TEMA), American Petroleum Institute (API), and National Board Inspection Code (NBIC). Local jurisdictional authorities (State, Commonwealth, or City) may require compliance with an industry Code or Standard or a combination of Codes and Standards. Pressure retaining items contain fluids (gases or liquids) under a pressure that may be either internal (a pressure acting on the inside of a pressure retaining item) or external (pressure acting on the outside of a pressure retaining item). Pressure retaining items are used to contain, move, or process various fluids. Commercial and government industries using pressure retaining items include but are not limited to chemical, petrochemical, process, food, pharmaceutical, water, oil, gas industries, electrical power generation (fossil, hydro, and nuclear), government energy and nuclear process facilities, and various manufacturing industries.

Pressure retaining items often require the addition of new access components due to process changes that require new locations of fluid (gas or liquid) access (either into or out of the pressure retaining item), for connection of testing or sampling lines, or for providing provision for physical internal inspection of/or entrance into the pressure retaining items.

The common method of providing new access to pressure retaining items is to cut or machine a hole in the pressure retaining item using very specific and exact dimensions and extremely tight tolerances. New access openings are either 1) set on the outer surface of the pressure retaining item and aligned and centered over the hole made in the pressure retaining item or 2) set into the hole that has been made in the pressure retaining item. For pipe or round tube nozzles set into the hole that has been made in the pressure retaining item it is often necessary to machine or grind a specific weld joint preparation in the edge of this hole such that the new access opening that is set into the opening can be welded to the pressure retaining item. This weld is then examined to assure its structural and pressure retaining integrity using the same methods or comparable methods to those used for other similar types of welds joints in the pressure retaining item during initial construction.

Pressure retaining items also often require the replacement of access components as a result of material degradation of an access component or pressure retaining material surrounding the access component. Degradation is defined as a change in state from that originally intended to the extent that an item that is identified as degraded is not capable of meeting one or more intended purposes. Degradation may include thinning of a material, cracks forming within or upon the surface of a material, pitting of a material, or general overall structural damage in a material. Degradation of a material, including material thinning, pitting or cracking, may be caused by but is not limited to erosion or corrosion. Material degradation can occur from a chemical reaction between the fluid contained by a pressure retaining item and its material of construction. Material degradation can occur due to movement or impingement of fluid against pressure retaining material of construction of a pressure retaining item. Corrosion, erosion or other mechanisms, either individually or in combination, can result in degradation of material that is required to maintain the structural and pressure retaining capability of pressure retaining items. Degradation of a material, including material geometrical changes or changes in a material physical property including but not limited to changes in material yield strength, tensile strength, modulus of elasticity, etc., may be caused by an imposed load, pressure, or temperature condition.

Material degradation can result in a potential hazardous operating condition wherein as-designed and constructed safety factors against fluid leakage or pressure retaining item structural integrity or pressure retaining item pressure boundary pressure retention capability are reduced. In severe material degradation conditions failure of pressure retaining items can occur. Pressure retaining item failure can result in affecting the safety of personnel safety and/or in economic losses.

Where material degradation is determined, assessments of remaining life and adequacy of pressure retaining item to remain in service while continuing to operate within the requisite factors of safety are performed. Where it is determined that a specific pressure retaining item does not have the requisite factor of safety to continue operation, several options are available including 1) changing the conditions under which that specific pressure retaining item is operated to conditions that are acceptable for continued safe operation, or 2) replacing or repairing unacceptable parts of pressure retaining items.

The common method of repair includes removal of the access component along with an adjacent section of pressure retaining item material including that material adjacent to the access opening determined to be unacceptable and replacement with a new section of material and a new access component of equivalent or better structural, pressure retaining, and/or corrosion and/or erosion resistance than that used in the original construction. New sections of replacement material and access components are most often installed by joining them to an existing pressure retaining item at locations with adequate material thickness for continued operation of the item using full or complete penetration fusion welds. This type of repair is generally referred to as a “return to original condition repair”.

The “return to original condition repair” method of repair is generally allowed by governing Codes and Standards for construction, operation, or inspection, and are also generally allowed by most jurisdictional authorities (State, Commonwealth, or City) in the United States. “Return to original condition repair” methods most often require using replacement material and access components that can be installed and have the new welds of the replacement parts examined for soundness, leak tightness, pressure integrity, and structural integrity using the same installation, examination and inspection techniques that were used in similar welds during initial construction of the pressure retaining item. To accomplish this repair with the requisite weld integrity assurance generally necessitates the costly field construction, examination, and inspection methodologies be employed.

“Return to original condition repair” method may result in equal or greater pressure retention and structural integrity factors of safety to those that existed at the time of original construction. The “Return to original condition repair” method for repair of pressure retaining items has several limitations or negative aspects including but not limited to:
1. require removal of pressure retaining items from service,
2. require detailed close-tolerance cutting, grinding, or machining out of pressure retaining item local material degraded areas,
3. require preparation of pressure retaining item remaining material for welding of the new replacement section of material and /or access component by cutting or grinding,
4. require exact cutting, curvature fabrication (by rolling, forming, or machining) and weld end preparation of the new section of material and /or access component material for fit-up,
5. may require use of weld joint backing strips. The backing strips may or may have to remain in place depending on their accessibility after welding. If left in place they may contribute to a reduction in a pressure retaining item factor of safety or even worse the acceleration of new local areas of corrosion or erosion due to the introduction of a new fluid flow path obstruction, and
6. may have extended time interval of exposure of personnel to lethal or hazardous fluid contents of a pressure retaining item such as chemical, gas, or radioactive fluid contents.

### BRIEF SUMMARY OF THE INVENTION

### Brief Description of the Invention

The Access Component for Pressure Retaining Item (PMCap-Nozzle), hereinafter referred to as “the invention” or “access component”, is a component used to provide access into a pressure retaining item. Piping, tubing, or hose may be attached to the component through which a fluid (gas or liquid) can either enter or exit the pressure retaining item. A cover may be attached to the invention which when the cover is removed provides for physical access into the pressure retaining item. The invention has self structural and pressure retention integrity and maintains the structural and pressure retention integrity of the pressure retaining item to which it is attached. The invention consists of a single component of metallic material that is welded to the surface of a pressure retaining item. The invention is used to 1) provide a new means of access to a pressure retaining item or 2) to provide for a replacement fluid or physical access to the pressure retaining item and, where necessary, replace an area of pressure retaining item pressure boundary wall that has degraded. The invention is installed by making an opening in the pressure retaining item and placing the invention over the opening and attaching the invention to the pressure retaining items surface by full or complete penetration fusion welding. The size of the opening made in the pressure retaining item is of such dimensions (diameter, or width and length) that the outside size (diameter or width and length) of the invention, at the location of its attachment to the pressure retaining item 1) covers the opening or 2) covers the opening and encapsulates some of the adjacent pressure retaining item material.

Where the invention is used to provide for new or replacement fluid or physical access to the pressure retaining item, the size of the opening in the pressure retaining item need only be large enough in area and of such shape that the required fluid flow rate requirements and associated limitations on pressure drop across the opening into or out of the pressure retaining item, or the required physical access area requirements, are complied with. The size of the inside opening of the invention at its attachment to the pressure retaining item is such that significantly larger hole sizes and associated larger hole size tolerances, than those required for installation of a new access opening by typical methods of setting the access component into (set-in) or onto (set-on) the pressure retaining item and attaching the new access opening by a fusion welding. Access openings are either 1) set-on the outer surface of the pressure retaining item and aligned and centered over a hole made in the pressure retaining item or 2) set-in a hole that has been made in the pressure retaining item. For set-on installations the size of the hole in the pressure retaining item is equal to that of the access component. For set-in installations the size of the hole in the pressure retaining item is slightly larger that the outside dimensions of the access component. For a set-in installation, it is often necessary to machine or grind a specific weld joint preparation in the edge of this hole to allow for attachment of the access component to the pressure retaining item by fusion welding. Thus use of the invention as opposed to the currently common approach being used to provide new fluid access openings can result in substantial labor and cost savings, due to there not being a need to make a hole in the pressure retaining item of a size that is closely matched within a specific tight tolerance to the size of the access opening being installed.

Where the invention is used to provide for replacement fluid and or physical access to the pressure retaining item and further to replace an area of pressure retaining item pressure boundary wall that has degraded, the size of the opening in the pressure retaining item need only be large enough in area and of such shape that the required fluid flow rate requirements and associated limitations on pressure drop across the opening into or out of the pressure retaining item, or the required physical access area requirements, are complied with. The size of the inside opening of the invention at its attachment to the pressure retaining item is such that it encapsulates the degraded pressure retaining item material.

The configuration of the invention is a single piece of metal that has a cavity on one side built into it and an opening within the cavity to allow for access to the internals of the pressure retaining component. The cavity portion of the invention allows for the invention having a skirt (hub) of material completely around its periphery that extends below the inner face surface of the invention. The invention can best be described by a comparison to one or more common items. To describe the invention in simple terms would be for one to compare its possible geometric configurations to those of 1) a standard shoe box cover penetrated by a hollow cylinder, 2) the lid of a jar penetrated by a hollow cylinder, 3) or an open sardine can penetrated by a hollow cylinder. These are only illustrative examples for simple comparison to the general geometric configuration of the invention. The invention can be constructed by bending, welding, machining, forming, forging, or casting a piece of metal to match a contour of a surface of a pressure retaining item.

The end of the extended skirt (hub) portion of the invention is complete or full penetration fusion welded to a pressure retaining item surface. The section of unacceptable pressure retaining item material that is encapsulated by the invention may continue to degrade further with no loss of pressure retaining or structural integrity of the pressure retaining item to which the invention is attached. The invention, based on an appropriate design and material selection that sizes the invention and its attachment welds appropriately for the intended purpose, can provide for assurance that a pressure retaining item to which the invention is attached, has, after attachment of the invention, an original or better factor of safety against leakage or failure and with equal or better corrosion/erosion resistance, allowance, or capability than that in the as-designed and as-constructed condition of the pressure retaining item. The weld joining the invention to a pressure retaining item would be a complete or full penetration fusion weld whose final as-welded configuration would allow for either a surface non-destructive examination or a complete through wall volumetric examination of the weld.

### Objective and Advantages of the Invention

The objective of the invention is to provide a simple, safe, cost effective, method of providing a new or replacement access opening in a pressure retaining component. A further objective is to provide a method of access opening installation that alleviates or eliminates many, if not all, of the negative aspects of some current access opening replacement or new installation methods as described in the previous section of this Specification entitled “BACKGROUND OF THE INVENTION”).

It is believed that the invention alleviates many of the negative aspects of some current access opening replacement or new installation methods and further allows for repair of degraded pressure retaining item degraded wall adjacent to the access opening and offers several advantages. Negative aspects of the current access opening replacement, adjacent pressure retaining item degraded wall repair, or new installation methods that are alleviated by the invention and several advantages of the invention over these methods include but are not limited to the following:

The invention:
1. by its use and attachment may only require minimal preparation of the pressure retaining item material for weld attachment of the invention in comparison to the traditional methods of replacement access opening methods and adjacent degraded pressure retaining item wall repair.
2. by its use and attachment may eliminate or minimize use of weld joint backing strips in the attachment weld between a pressure retaining item and the invention which then by not using said weld joint backing strip would substantially reduce or eliminate in most cases a requirement to impose or consider a reduction in the pressure retaining item factor of safety as applicable to a pressure retaining item's pressure retention or structural integrity.
3. by its use and attachment may eliminate or minimize use of weld joint backing strips in the attachment weld between a pressure retaining item and the invention which then by not using said weld joint backing strip would substantially reduce or eliminate an attachment with a geometrical configuration that would contribute to acceleration of existing areas of erosion or corrosion or lead to new areas that would be subjected to erosion or corrosion at rates in excess of those that existed prior to the attachment of the invention.
4. is not limited to a specific geometrical shape. It may be constructed to most any regular or irregular shape including but not limited to round, square, rectangular, obround, oval, triangular, or any combination of the these shapes.
5. by its use and attachment may eliminate the need to repair or replace adjacent degraded pressure retaining item wall.

### BRIEF DESCRIPTION OF THE SEVERAL VIEWS OF THE DRAWING

General

There is one drawing that describes the invention, Drawing Sheet 1/1. Drawing Sheet 1/1 provides a general arrangement and general details of an Access Component for Pressure Retaining Item (PMCap-Nozzle). The invention consists of a pressure maintenance cap and a pipe or tube nozzle penetrating and attached to the.

The pressure maintenance cap portion of the invention is depicted in the drawing as round. However, is not limited to shape. The outer periphery of the pressure maintenance cap portion of the invention may be constructed to most any regular or irregular shape including but not limited to round, square, rectangular, obround, oval, triangular, or any combination of the these shapes. The pipe or tube nozzle is generally round. The Drawing Sheet 1/1 is provided to describe the general concept of the invention but the drawing does not describe all possible detailed configurations or geometrical shapes of the invention.

Drawing Sheet 1/1—FIG. 1

FIG. 1 depicts a plan view that shows how the invention (in an outer periphery round configuration) would appear if one were to view a surface of a pressure retaining item (Pressure Retaining Item Element 1) after the invention had been attached. The invention is comprised of two major elements consisting of a pipe or tube identified as a nozzle (Nozzle Item 8) and a pressure retaining metal material component identified as pressure maintenance cap (Pressure Maintenance Cap Item 9). The pressure maintenance cap (Pressure Maintenance Cap Item 9) has its parts or elements further identified as 1) outer solid circular line (Outer Wall Line Element 2), 2) inner wall line (Inner Wall Line Element 5), 3) inner surface (Surface Element 6), 4) edge (Edge of Element 7), 5) angle (Angle Element A), 6) dimension (Dimension Element B), and 7) skirt (hub) (Skirt (hub) Element E). The surface of a pressure retaining item (Pressure Retaining Item Element 1) could be, as an example: 1) a surface of a cylindrical pressure vessel shell, 2) a surface of a pressure vessel end closure head, 3) a surface of a pipe, 4) a surface of a shell of a flat bottomed storage tank, 5) a compound curved surface of a pump body, or 6) a compound curved surface of a valve body, amongst other pressure retaining item surfaces to which the invention can be attached. The irregular solid line (Boundary Line Element 4) depicts the boundary of a small section of a pressure retaining item surface that is being shown in the plan view (FIG. 1). The outer solid circular line (Outer Wall Line Element 2) depicts the periphery of the invention and the outer wall of the skirt (hub) (Skirt (hub) Element E). The inner dotted circular inner wall line (Inner Wall Line Element 5) depicts the inner wall of the invention's skirt (hub). The innermost two concentric circles depict a pipe or tube nozzle (Nozzle Element 8) that penetrates and is welded to the pressure maintenance cap (Pressure Maintenance Cap Element 9). The upper left hand corner of FIG. 1 depicts a sample weld joint connection configuration (Weld Symbol Element W) of the invention to a pressure retaining item (Pressure Retaining Item Element 1). Weld Symbol Element W depicts a complete or full penetration weld supplemented by a fillet weld with this fillet weld size being specifically dependent on a pressure loading and geometry of a specific pressure retaining item, a Code or Standard (a Code or Standard is described in the section of this Specification entitled “BACKGROUND OF THE INVENTION”), and the invention size, shape, and geometry.

Drawing Sheet 1/1—FIG. 2 and FIG. 3

FIG. 2 shows how the invention would look if one were to cut through the center of the invention (View Line 2-2) after it being attached to a pressure retaining material (Pressure Retaining Item Element 1). Also note that this view (FIG. 2) presents the invention as placed on a cylindrical surface. This is only an example of the geometry of surface to which the invention can be applied. FIG. 2 also shows how the invention may be constructed of more than one single component of material (Nozzle Element 8 and Pressure Maintenance Cap Element 9) and how these two components are attached by welding (Weld Z).

The skirt (hub) (Skirt (hub) Element E) of the invention comprises that volume of metal that lies between a) the inner surface (Surface Element 6) of the pressure maintenance cap (Pressure Maintenance Cap Element 9) portion of the invention that is parallel to the pressure retaining material surface pressure retaining item (Pressure Retaining Item Element 1), and extends around the periphery of the invention and further extending in approximately a perpendicular direction from the of the pressure maintenance cap inner surface (Inner Surface Element 6) to a point where the end of this volume of metal can be placed such that it is in contact with or just slightly above the surface of the pressure retaining item (Pressure Retaining Item Element 1). The skirt (hub) (Skirt (hub) Element E) is beveled at the point where it would be placed in contact with or just slightly above the surface of the pressure retaining material at an angle (Angle Element A) suitable for the welding process and procedure selected such that complete or full penetration fusion metal welding the skirt (hub) (Skirt (hub) Element E) of the invention to the pressure retaining item (Pressure Retaining Item Element 1) can achieve complete coalescence of metal at the interface of the invention skirt (hub) (Skirt (hub) Element E) and the pressure retaining item (Pressure Retaining Item Element 1). The point of contact between the edge of pressure maintenance cap (Pressure Maintenance Cap Element 9) of the skirt (hub) (Skirt (hub) Element E) at the beveled end where in the skirt (hub) (Skirt (hub) Element E) is in contact with or just slightly above the surface of the pressure retaining item (Pressure Retaining Item Element 1) may be a knife edge configuration or have some very small flat dimension (Dimension Element B). The small flat dimension (Dimension Element B) is of such a length that for the welding process and procedure selected, complete or full penetration fusion metal welding the skirt (hub) (Skirt (hub) Element E) of the invention to the pressure retaining item (Pressure Retaining Item Element 1) can achieve complete coalescence of metal at the interface of the invention skirt (hub) (Skirt (hub) Element E) and the pressure retaining item (Pressure Retaining Item Element 1).

The edge (Edge D) is the edge of the hole that is cut in the pressure retaining item (Pressure Retaining Item Element 1) at installation and is shown as a jagged cut, as there is no requirement for a precise hole to be made for installation of the invention.

Drawing Sheet 1/1—FIG. 3

FIG. 3 shows more detail of the attachment of the invention to the pressure retaining item (Pressure Retaining Item Element 1). FIG. 3 shows the basic configuration of the skirt (hub) (Skirt (hub) Element E) of the invention at the attachment location of the invention where it is placed against the outer surface of the pressure retaining item (Pressure Retaining Item Element 1). A description of a weld preparation detail is shown as the beveled portion of the skirt (hub) (Skirt (hub) Element E) having a bevel angle (Angle Element A). The pressure maintenance cap (Pressure Maintenance Cap Element 9) skirt (hub) (Skirt (hub) Element E) can be manufactured with various material thickness and dimensions such that design pressure and loading requirements are satisfied. The edge (Edge of Element 7) of the skirt (hub) (Skirt (hub) Element E) which is in contact with or just slightly above the outer surface of the pressure retaining item (Pressure Retaining Item Element 1) is contoured such that the edge of the skirt (hub) (Skirt (hub) Element E) and the surface of the pressure retaining item (Pressure Retaining Item Element 1) will match each other at their juncture point.

### DETAILED DESCRIPTION OF THE INVENTION

General

The Access Component for Pressure Retaining Item (PMCap-Nozzle), hereinafter referred to as “the invention”, is a component that is attached to a pressure retaining item and provides for access into the pressure retaining item. The invention consists of a component of metallic material that is complete or full penetration fusion welded to the surface of a pressure retaining item. The invention is welded directly over a section of the pressure retaining item where access into the pressure retaining item is desired. Installation of the invention on a pressure retaining item can be accomplished while retaining the structural and pressure retaining integrity, and allowance for corrosion and/or erosion of a pressure retaining item to equal or better conditions than the original as-designed or as-constructed condition of the pressure retaining item without the access opening provided by the invention.

Construction of Invention

The invention is shown in sample invention Drawing Sheet 1/1 (sample drawing of a round shape invention). The invention can be of any shape including but not limited to round, square, rectangular, obround, oval, triangular, or any combination of the these shapes.

The configuration of the invention is a component of metal that has a cavity (Cavity Element C, FIGS. 2 and 3) on one side built into it. The cavity (Cavity Element C, FIGS. 2 and 3) portion of the invention allows for the invention having a skirt (hub) (Skirt (hub) Element E, FIGS. 2 and 3) of material completely around its periphery that extends below the inner face surface (Surface Element 6) of the invention. The invention can best be described by a comparison to one or more common items. To describe the invention in simple terms would be for one to compare its possible geometric configurations to those of 1) a standard shoe box cover, 2) the lid of a jar, 3) or an open sardine can, with a hollow component penetrating it for access into the pressure retaining material after attachment of the invention. These are only illustrative examples for simple comparison to the general geometric configuration of the invention. The invention can be constructed by bending, welding, machining, forming, forging, or casting a piece of metal to match a contour of a surface of a pressure retaining item.

The invention can be manufactured or fabricated from a single piece of metal plate, forging, or casting, or can be fabricated using a combination of metal plate, forging, or casting parts by welding these pieces together to make the invention. Curved areas of the invention may be made by rolling the invention in a set of plate rollers or in a break press forming machine to the desired curvature. During this rolling or break press forming process the cavity of the invention may be filled with a piece of metal plate to prevent damage of the weld end portion of the invention skirt (hub). For inventions of very thick parts, the invention may be heated before the rolling or break press forming process to facilitate the fabrication process. Curved areas of the invention may be made by machining of parts to achieve the desired curvatures. The invention may be manufactured by the casting process wherein all parts including the curved parts of the invention are achieved during the casting process. A forming process wherein the configuration of the invention is arrived at by using a die and forming process may be used to manufacture the invention.

The final process of manufacture may consist of machining and grinding to arrive at the final configuration.

Drawing Elements

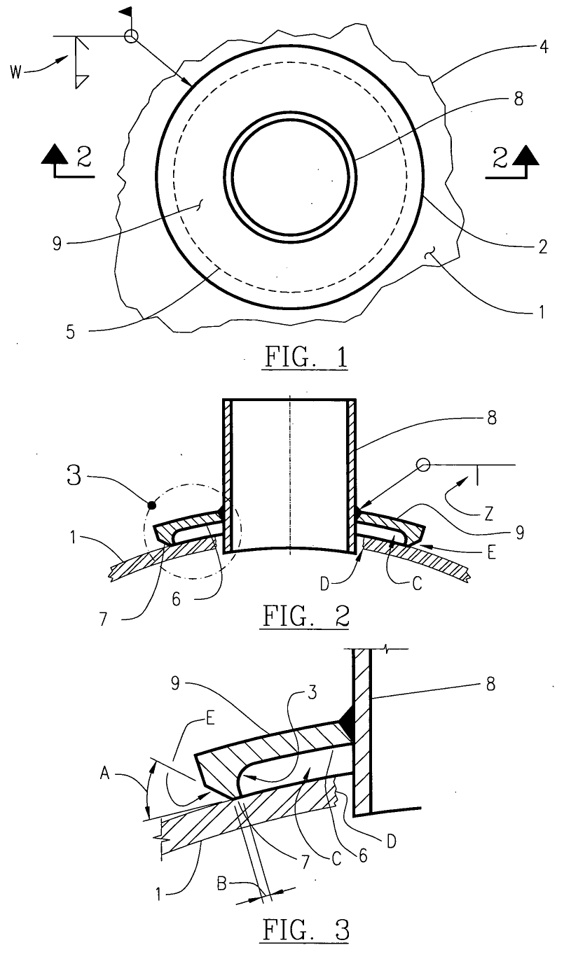

The invention maintains structural integrity of a pressure retaining item (Pressure Retaining Item Element 1, FIGS. 1, 2, and 3) by its being designed to provide the requisite structural integrity of a pressure retaining item.

The edge (Edge D, FIGS. 2 and 3) is the edge of the hole that is cut in the pressure retaining item (Pressure Retaining Item Element 1, FIGS. 1, 2 and 3) at installation and is shown as a jagged cut, as there is no requirement for a precise hole to be made for installation of the invention.

The skirt (hub) (Skirt (hub) Element E, FIGS. 2 and 3) which runs around the periphery of the pressure maintenance cap (Pressure Maintenance Cap Element 9) portion of the invention maintains pressure integrity and structural integrity of a pressure retaining item (Pressure Retaining item Element 1, FIGS. 1, 2, and 3) by its being designed to provide the requisite structural integrity of the pressure retaining material and transfer of loading form pressure retaining item material adjacent to the attached invention into and then through the invention back into a pressure retaining material. The space (Space Element E, FIGS. 2 and 3) of the invention allows for the invention to be complete or full penetration fusion weld joined at the skirt (hub) (Skirt (hub) Element E, FIGS. 2 and 3) end edge of pressure maintenance cap (Pressure Maintenance Cap Element 9, FIGS. 2 and 3) to a pressure retaining item (Pressure Retaining item Element 1, FIGS. 1, 2, and 3). This type of complete or full or complete penetration fusion weld allows for a complete volumetric examination of a weld to be performed to insure structural integrity of a weld joint of this type weld joint attachment. The fabrication of curved surfaces at the skirt (hub) (Skirt (hub) Element E, FIGS. 2 and 3) end edge of pressure maintenance cap (Pressure Maintenance Cap Element 9, FIGS. 2 and 3) allows for mating of the invention to the surface of a pressure retaining item (Pressure Retaining Item Element 1, FIGS. 1, 2, and 3). All machined radius (Radius Element 3, FIG. 3) of the pressure cap (Pressure Maintenance Cap Element 9) portion or the invention (can be designed to a size required to reduce stress concentrations during operation of a pressure retaining item with the invention installed. The weld between the invention and the pressure retaining item (Pressure Retaining Item Element 1, FIGS. 1, 2, and 3) would be a full or complete penetration fusion weld supplemented by a fillet weld. Fillet welds supplementing full or penetration fusion welds attaching the invention to a pressure retaining item (Pressure Retaining Item Element 1, FIGS. 1, 2, and 3) can be sized for the requisite load capacity, structural integrity, and pressure integrity. Fillet welds can be sized to comply with requirements that may apply to fillet welds supplementing full or complete penetration fusion welds or to fillet welds in general as required by any Code or Standard being imposed by jurisdictional authorities or governing the overall design and construction of the invention.

Value and Improvement of Invention over Current Methods

The invention offers several improvements and areas of increased value over current methods of adding access openings to pressure retaining items. The following includes several of these values and improvements:
1. Cutting of hole in pressure retaining item
   “Current Method”—precise hole size is required.
   “Invention”—oversized with large tolerance on hole size may be used.
2. Preparation of pressure retaining item material for welding of access opening
   “Current Method”—precise hole welding edge preparation is required for access components that are set-on the surface of the pressure retaining item in preparation of welding the access component to the pressure retaining item
   “Invention”—no weld preparation of existing pressure retaining item hole edge require—as cut hole edge condition acceptable.
3. Installation of weld joint backing strips (Backing strips can cause a reduction in the pressure retaining item factor of safety or even worse the acceleration of new local areas of corrosion or erosion)
   “Current Method”—may be required
   “Invention”—not required
5. Improved structural and pressure retaining integrity of pressure retaining item at location of material degradation
   “Current Method”—possible
   Invention—generally yes
6. Repair Hardware Cost
   “Current Method”—generally lower than invention
   Invention—generally higher
7. Installation Cost
   “Current method”—generally higher than invention
   Invention—generally lower
8. Economic Cost Due to Facility/Process Downtime
   “Current method”—generally much higher than invention
   Invention—generally very low

The attachment weld joining the invention to a pressure retaining item would be a complete or full penetration fusion weld whose final as welded configuration allows for a complete through wall volumetric examination of the weld to be performed (generally by ultrasonic examination

What I claim as my invention is:

1. A metal component for providing access into a pressure retaining item constructed of a pressure retaining material comprising a pressure maintenance cap and a pipe or tube nozzle where the pipe or tube nozzle penetrate is attached to the pressure maintenance cap by fusion welding, and where the pressure maintenance cap has an inner face surface the extends substantially perpendicular from the inner face surface wherein the skirt (hub) has an edge that extends substantially perpendicular form the inner face surface, wherein the skirt has an edge in direct contact with the pressure retaining material and the skirt surrounds an opening in the pressure retaining item, and wherein the pressure maintenance cap is adapted to be integrally attached only by full or complete penetration fusion welding to form a complete coalescence of metal of the skirt (hub) of the pressure maintenance cap and the pressure retaining material such that a space between the pressure retaining material and the pressure maintenance cap can be formed, and where a pipe or tube nozzle is attached to the pressure maintenance cap by a fusion welding process that forms a complete or partial coalescence of metal of the pipe or round tube nozzle and the pressure maintenance cap and wherein the opening or inside hole of the pipe or tube nozzle of the metal component lies essentially parallel to and above the hole in the pressure retaining item and wherein the centerline hole in the pipe or round tube nozzle may be but are not necessarily concentric but are located such that the flow or a process fluid from the pipe or tube nozzle thru and into the pressure retaining item or from the pressure retaining item into the pipe are not impeded or restricted, and wherein the pipe or round tube nozzle may extend thru the hole and in the pressure retaining item into the pressure retaining item without interference with the hole in the pressure retaining item.

2. A metal component in accordance with claim 1 wherein said raised skirt is shaped in cross section in the form of a bevel

3. A metal component in accordance with claim 1 which is casted

4. A metal component in accordance with claim 1 which is forged

5. A metal component in accordance with claim 1 which is machined

6. A metal component according to claim 1 that allows for the flow of process fluid and a part of the component that allows for the centerline of the opening in that component and the centerline of the hole in the pressure retaining item to not be in a coincided position and where in the aforementioned non-coincided position the individual positions of the holes in both items would allow for a complete flow of process fluid thru the two openings and where in that location position the component and the pressure retaining item lie adjacent to each other such that the skirt (hub) element of component is positioned at an adjacent angle such that the two items may be adjoined by full or complete penetration fusion weld.

7. A metal component in accordance with claim 1 wherein said inner face surface is formed to be substantially parallel to the section of the pressure retaining surface over which the component is to be placed and subsequently attached to

8. A component according to claim 1 that can be extended in a plane parallel to the surface of the pressure retaining item such that any area of pressure retaining item that is considered to be in a degraded condition may be encapsulated by the component and where the component contains all the requisite material to replace the degraded material that is necessary for structural integrity, pressure retention integrity and corrosion and erosion resistance capability of the portion of degraded shell wall that the component is replacing.

9. A method for of repairing a degraded section of pressure retaining material comprising the steps of:
a. Obtaining a component as identified in claim 1 having a portion of the component having an inner face surface and an outer face surface that both lie above and parallel to the degraded section of pressure retaining material and also having an outer face and a raised skirt (hub) near or on the periphery of said inner face surface that extends substantially perpendicular from the inner face surface, and that has a pipe or tube that penetrates and is attached to said pressure maintenance cap portion of the component that contains the aforementioned inner face surface and outer face surface:
b. Placing said component with said skirt (hub) in direct contact with the pressure retaining material wherein the skirt (hub) is in direct contact or just slightly above the pressure retaining material wherein the skirt (hub) surrounds the degraded section of the pressure retaining material that also includes hole cut into the pressure retaining material where the hoes has been cut into the pressure retaining material for the purpose of allowing fluid to flow thru and between the hole in the pressure retaining material and the hole in the pipe or tube portion of the component; and
c. Complete penetration fusion metal welding the skirt (hub) of the component to the pressure retaining material wherein complete coalescence of metal of the skirt and pressure retaining material is achieved.

10. A method in accordance with claim 9 including the step of forming said inner face surface such that it is substantially parallel to the degraded or non-degraded section of pressure retaining material

11. A method in accordance with claim 9 wherein said fusion metal welding step includes the step of complete penetration fusion metal welding a skirt (hub) beveled in cross section.

12. A method in accordance with claim 9 where the step of obtaining the pressure maintenance cap portion of the metal component that has the and outer faces that are installed essentially parallel to the surface of the pressure retaining item includes the step of filling the area of the pressure maintenance cap portion of the metal component that has the inner and outer faces within the skirt (hub) with a metal plate, and forming the combined metal plate and pressure maintenance cap portion of the metal component to the shape of the pressure retaining material without damaging the skirt (hub).

13. A reinforced pressure retaining item have a degraded section comprised of degraded pressure retaining material, comprising: a metal component according to claim 1:
said metal component being positioned on said pressure retaining material such that the skirt (hub) of the pressure maintenance cap portion of the metal component surrounds the degraded section of the pressure retaining material;
said skirt (hub) having and edge in direct contact with or just slightly above and full or complete penetration fusion welded to the pressure retaining material of the pressure retaining item; and
said skirt (hub) being integrally attached to the pressure retaining material by full or complete penetration fusion welding which forms a complete coalescence of metal of the skirt (hub) and the pressure retaining material.

14. An apparatus in accordance with claim 13 wherein said metal component is machined.

15. An apparatus in accordance with claim 13 wherein said metal component is casted.

16. An apparatus in accordance with claim 13 wherein said metal component is forged.

17. An apparatus in accordance with claim 13 wherein said metal component is formed by welding said skirt (hub) to the inner face surface of the pressure maintenance cap portion of the metal component and welding the said nozzle to edge of the pressure maintenance cap portion of the metal component that lies essentially perpendicular to and between aforementioned inner and outer surfaces.

18. An apparatus in accordance with claim 13 wherein the skirt (hub) of the pressure maintenance cap portion of the metal component is beveled in cross section.

19. An apparatus in accordance with claim 13 including a fillet weld around the periphery of said pressure maintenance cap portion of the metal component portion of said metal component.

20. An apparatus in accordance with claim 13 wherein said inner surface of said pressure maintenance cap portion of the metal component is formed to be substantially parallel to said surface of the section of pressure retaining material over which it is placed at installation.
